(19) United States
(12) Patent Application Publication
(10) Pub. No.: US 2023/0417906 A1
(43) Pub. Date: Dec. 28, 2023

(54) VEHICULAR RADAR SENSING SYSTEM WITH EVOLVING RADAR SCAN CONFIGURATIONS

(71) Applicant: Magna Electronics Inc., Auburn Hills, MI (US)

(72) Inventor: Maria Gatz, Munich (DE)

(21) Appl. No.: 18/340,103

(22) Filed: Jun. 23, 2023

Related U.S. Application Data
(60) Provisional application No. 63/368,517, filed on Jul. 15, 2022.
(60) Provisional application No. 63/367,079, filed on Jun. 27, 2022.

(51) Int. Cl. G01S 13/931; G06N 3/126

(52) U.S. Cl. CPC G01S 13/931; G06N 3/126

(57) ABSTRACT

A method for generating an optimal scan configuration for a vehicular radar sensing system includes obtaining configurable scan parameters for the vehicular radar sensing system, and receiving a target system specification for the vehicular radar sensing system. The target system specification includes at least one system specification parameter. At least one relationship between the configurable scan parameters and the at least one system specification parameter is derived. A population of solutions using the at least one relationship is generated using a genetic algorithm. A potential system specification is determined from the population. The method determines whether the potential system specification satisfies a cost threshold and, in response to determining that the potential system specification satisfies the cost threshold, the potential system specification is provided.

### CROSS REFERENCE TO RELATED APPLICATIONS

The present application claims the filing benefits of U.S. provisional application Ser. No. 63/368,517, filed Jul. 15, 2022, and U.S. provisional application Ser. No. 63/367,079, filed Jun. 27, 2022, which are hereby incorporated herein by reference in their entireties.

### FIELD OF THE INVENTION

The present invention relates generally to a vehicle sensing system for a vehicle and, more particularly, a vehicle sensing system that utilizes one or more radar sensors at a vehicle.

### BACKGROUND OF THE INVENTION

Use of radar sensors in vehicle sensing systems is common and known. Examples of such known systems are described in U.S. Pat. Nos. 9,146,898; 8,027,029 and/or 8,013,780, which are hereby incorporated herein by reference in their entireties.

### SUMMARY OF THE INVENTION

A method for generating an optimal scan configuration for a vehicular radar sensing system includes obtaining, from a user device of a designer of the vehicular radar sensing system, a plurality of configurable scan parameters for the vehicular radar sensing system. The method also includes receiving a target system specification for the vehicular radar sensing system. The target system specification includes at least one system specification parameter for the vehicular radar sensing system. The method includes deriving at least one relationship between the plurality of configurable scan parameters and the at least one system specification parameters and generating, using a genetic algorithm, a population of solutions using the at least one relationship. The method includes determining, from the population of solutions, a potential system specification. The potential system specification defines values for each of the plurality of configurable scan parameters for use by the designer in designing the vehicular radar sensing system. The method includes determining whether the potential system specification satisfies a cost threshold and, in response to determining that the potential system specification satisfies the cost threshold, providing, to the user device, the potential system specification.

Another method for generating at least one optimal scan configuration for a vehicular radar sensing system includes generating a plurality of random radar scan configurations. Each radar scan configuration of the plurality of random radar scan configurations includes a plurality of randomized parameters. For each respective radar scan configuration of the plurality of random radar scan configurations, the method includes determining a cost value using a cost function. The cost function is based on a target system specification including at least one system specification parameter. The method also includes selecting a subset of radar scan configurations from the plurality of random radar scan configurations based on the cost value of each respective radar scan configuration and generating a second plurality of radar scan configurations from the subset of radar scan configurations. For each respective radar scan configuration of the second plurality of radar scan configurations, the method includes determining the cost value using the cost function. The method includes providing a subset of the second plurality of radar scan configurations based on the cost values.

These and other objects, advantages, purposes and features of the present invention will become apparent upon review of the following specification in conjunction with the drawings.

### BRIEF DESCRIPTION OF THE DRAWINGS

FIG. 1A is a perspective view of a vehicle with a sensing system that incorporates a radar sensor;

FIG. 1B is a plan view of a vehicle with the sensing system of FIG. 1A and a plurality of vehicular driving assistance systems;

FIG. 2 is a table of exemplary radar scan configuration parameters;

FIG. 3 is a table of estimated brute force execution times for radar scan configurations;

FIG. 4 is a table of estimated global search execution times for radar scan configurations; and

FIG. 5 is a block diagram for generating radar scan configurations.

### DESCRIPTION OF THE PREFERRED EMBODIMENTS

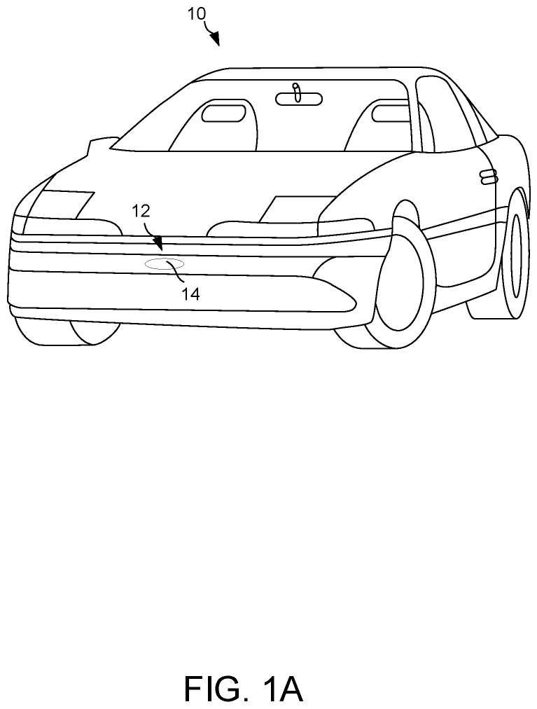

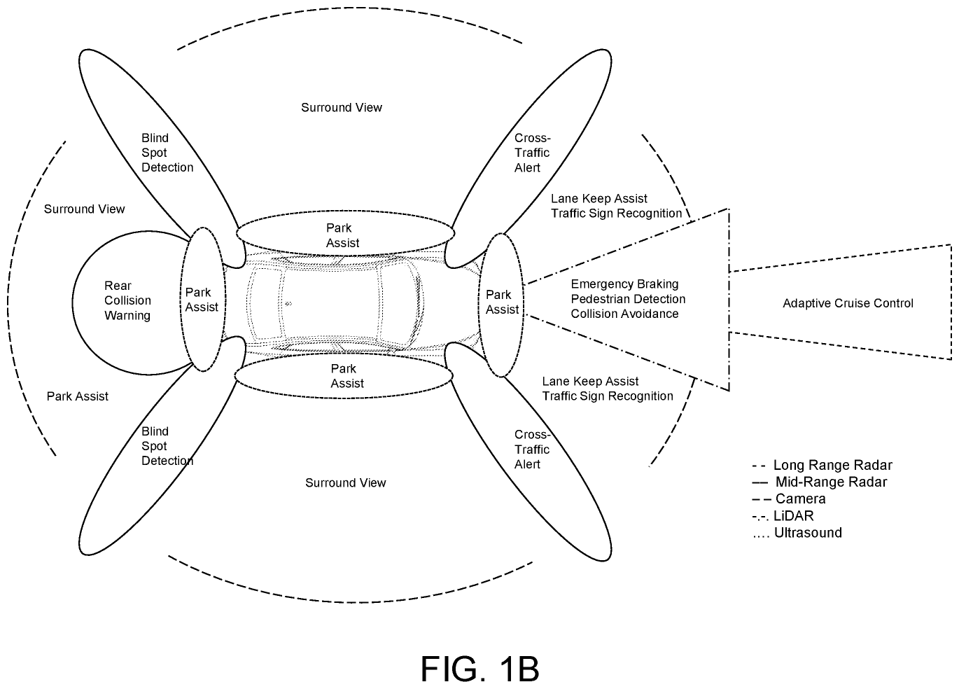

Referring now to the drawings and the illustrative embodiments depicted therein, a vehicle 10 (FIG. 1A) includes a vehicular driving assistance system or sensing system 12 that includes at least one radar sensor unit, such as a forward facing radar sensor unit 14 and/or one or more corner radar sensors (and the system may optionally include multiple exterior facing sensors, such as cameras, radar, lidar, and/or other sensors, such as a rearward facing sensor at the rear of the vehicle, and a sideward/rearward facing sensor at respective sides of the vehicle), which sense regions exterior of the vehicle. The sensing system 12 includes a control or electronic control unit (ECU) that includes a data processor that is operable to process data captured by the radar sensor(s). The sensing system may also include a radar sensor that includes a plurality of transmitters that transmit radio signals via a plurality of antennas. The radar sensor also includes a plurality of receivers that receive radio signals via the plurality of antennas. The received radio signals are transmitted radio signals that are reflected from an object. The ECU or processor is operable to process the received radio signals to sense or detect the object that the received radio signals reflected from. The ECU or sensing system 12 may be part of a driving assist system of the vehicle, with the driving assist system controlling at least one function or feature of the vehicle (such as to provide autonomous driving control of the vehicle) responsive to processing of the data captured by the radar sensors. The data transfer or signal communication from the sensor to the ECU may comprise any suitable data or communication link, such as a vehicle network bus or the like of the equipped vehicle.

Radar sensors are a common sensor included on modern vehicles. For example, many vehicles include one or more driving assistance systems 12 (FIG. 1B) that use one or more radar sensors of a sensing system (FIG. 1A). Configuration of radar systems requires selection of a number of radar scan parameters (center frequency, wavelength, duty cycle, symbol rate, etc.). However, selecting an optimal configuration of radar scan parameters according to a target radar specification (e.g. specific system key performance indicators (KPIs)/specific original equipment manufacturer (OEM) request, or other requirements) is a difficult task. The radar scan configuration is a customized configuration unique to each target specification and use case applications of the radar system. The configuration must be specifically derived each time a new radar application is considered. For example, a radar scan configuration may be a combination of approximately nineteen co-dependent parameters, each with a possible range of values (e.g. five to ten values each).

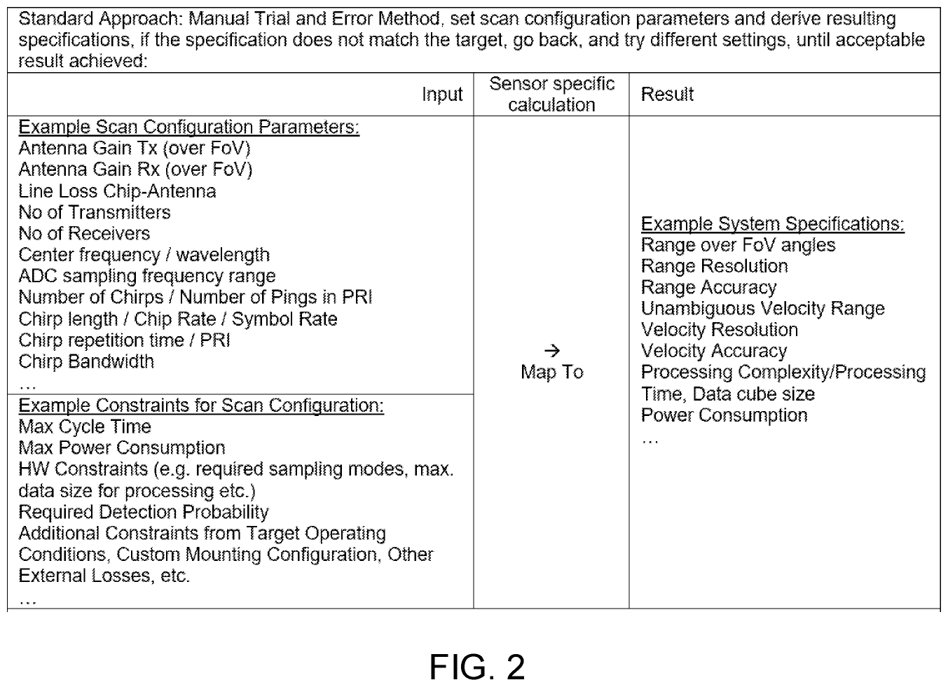

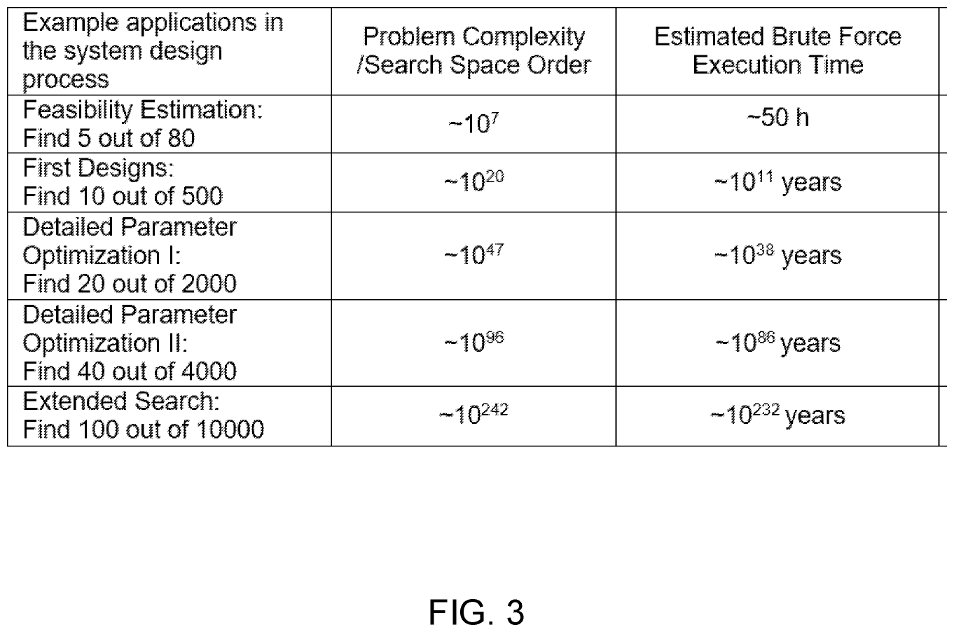

The radar scan configuration is a customized configuration unique to each target system specification and use case applications of the sensor system. Depending on the level of design or analysis a radar scan configuration may be a combination of approximately five to forty co-dependent parameters, each with a possible range of feasible values. FIG. 2 illustrates a table of exemplary parameters mapped using the conventional technique (i.e., using manual trial and error method). The result is a system specification made up of over twenty parameters that describe the basic key performance indicators (KPIs) of the sensing system. These parameters are directly connected and cannot be considered individually. Accordingly, these parameters must be optimized together as a set. FIG. 3 includes a table that illustrates search space size and estimated brute force execution time for different numbers of parameters. For example, assuming a conservative number of parameters (i.e., twenty-two parameters), the estimate of the problem space divided by the search space is over 10²² combinations. To derive the optimal configuration with a brute force approach, assuming perfect problem definition on first try and very good computing resources (e.g., 0.1 seconds per evaluation) would take approximately 2.5×10¹⁵ years to compute, which makes brute forcing infeasible. Moreover, the set of configuration and specification parameters could vary slightly depending on different radar systems and technologies, therefore slightly extending or reducing the search space. Instead, the problem is currently approached with a time-intensive and labor-intensive manual trial and error method requiring significant experience of system design engineers.

Designers often use conventional scan configuration manual design spreadsheets to optimize parameters by hand. For example, the spreadsheet may include white columns with the configurable parameters, shaded columns with the resulting system specification parameters, and an indication of system characteristics in graphs (e.g. signal-to-noise ratio (SNR), detection coverage, etc.). This manual design process can require a very long time (e.g., weeks or months) for a skilled engineer and does not guarantee achieving the most optimal configuration (only an acceptable solution achievable within a specific timeframe and based on the individual judgment of the system design engineer). The manual design process can also at best produce single acceptable configurations, as it is not feasible to derive a significant amount of configurations using the manual process. This fails to provide flexibility for the further system design process and may impose additional difficult design constraints on the rest of the system.

Implementations herein includes systems and methods to derive optimal scan configurations for (e.g., automotive) radar system design that significantly reduce the time and effort required for the system concept design and provides an improved and larger set of solutions, thereby significantly increasing the flexibility of the system. The systems and methods can be used with only basic knowledge. This enables the process to be much more accessible to development and management teams and to significantly reduce the expertise required for day-to-day use. This significantly reduces bottlenecks in the development process.

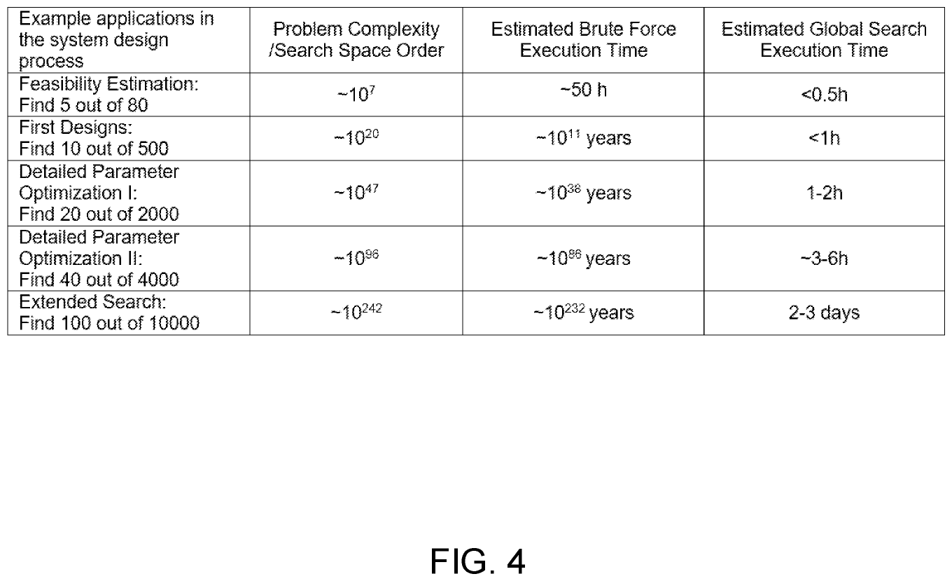

Automating such optimization problems poses many challenges, and the problem complexity grows quickly when solving for more and more detailed system configurations. A brute force optimization approach (which would test all possible combinations of the scan configuration parameters and find the absolute best solution out of all available settings) is not feasible (FIG. 3). Therefore, a global optimization technique is adapted and applied to help solve the complexity challenge and significantly reduce the time required to achieve the optimal set of results. FIG. 4 includes a table comparing the estimated brute force execution time to the estimated global search execution time as discussed in more detail below.

The system includes an algorithm that includes a set of functions that may execute on offline or online on a computing device that includes data processing hardware (e.g., a laptop, a desktop, a server, a distributed computing network or “cloud” computing, etc.). The computing device includes, for example, a processor, memory, a storage device, a high-speed interface/controller connecting to the memory and high-speed expansion ports, and a low speed interface/controller connecting to a low speed bus and a storage device. The system, using the data processing hardware, produces a set (e.g., of user defined size) of optimized radar scan configurations/designs that can be used as a direct solution or for further manual evaluation which constitutes an essential step in radar system design. The set of optimal solutions can be as large as the size of the population of solutions. For example, as described in more detail below, when the population has a size of 100, the system can produce 100 optimal solutions within a single result. This size can be further extended by extracting best results from any generation.

The system includes one or more heuristic global optimization (i.e., global search) algorithms. The system first uses (from the category of evolutionary algorithms) genetic algorithms and then optionally extends the method with a calculus or heuristic based optimal local search (e.g. gradient descent, simulated annealing). The system may extend this method to other heuristic based global search methods (e.g. ant colony, particle swarm, pattern search, etc.).

The system first executes a scan configuration global search using a genetic algorithm (i.e., an algorithm or method for solving both constrained and unconstrained optimization problems that is based on natural selection, the process that drives biological evolution, with the genetic algorithm repeatedly modifying a population of individual solutions). For example, a population is created out of the radar configurable scan parameters that are encoded in genes/chromosomes (e.g., within one-dimensional genes). The resulting system specification is used as an input into a cost function (which also may be referred to herein as a fitness function). The cost function represents the ‘evolutionary pressure’ that guides the evolution of the scan configurations. Specific rules for the selection, crossover, and/or mutation are defined. Based on these evolutionary rules, some genes are selected for reproduction, and generate offspring until a new population is created. This process is repeated over multiple generations, until a specific number of evolutionary loops are executed or the cost function of a defined number of elements in the population has reached a specific desired level (e.g., a desired threshold is satisfied). After the global search has concluded, the system may use a supplementary local search (i.e., a local search algorithm) to determine a refined or more optimal solution within the entire search space. However, this is purely optional, as for many use cases, the global search provides a satisfactory result.

The system may be implemented in a preferred programming language of the user, such as scripting languages with easy array handling (e.g. Matlab, Python, JavaScript, etc.) and integrated with legacy methods and tools. The system may be executed in a development environment, web application (e.g., via a browser), via a macro, or as a standalone application, depending on the chosen environment of the user. The target system specification (e.g., derived from system requirements and/or OEM requirements), as well as specific fixed constraints that are predetermined (FIG. 2) may be received as an input to the system. The configurable scan parameters may be built in and the relationships between the parameters and the system specification parameters may be automatically derived and programmed into the algorithm logic. The system may then execute the algorithm to start the evolutionary process and generate or produce the set of optimal system designs automatically.

The system may choose the set of relevant system designs for evaluation out of the global search space and evaluate the designs in, for example, minutes on small populations to hours on large populations. Therefore, the system may reduce the system design step related to the scan configuration from weeks to minutes/hours. The system may provide not only a single optimal configuration but a set of optimal configurations of any size configurable by a user (e.g., a set of three configurations, five configurations, ten configurations, etc.) or based on the system specifications. The set may be further evaluated for additional system design criteria/constraints. For example the set may be evaluated for cost, ease of manufacture, ease of installation, etc.

Thus, the system defines a cost function to define the ‘evolutionary pressure’ in terms of a mathematical system design description and determines how to normalize and sum/integrate over cost function building blocks with different meanings, units, ranges, etc. The system selects settings for the global search method. For example, in the case of genetic algorithms, the system may choose the ‘evolutionary principles’ such as population encoding, survival rate, selection, crossover, mating, mutation, etc. Each of these ‘settings’ may have an impact on the performance and convergence rate of the method. The system, based on these settings, executes the genetic algorithm to derive one or more optimal scan configurations.

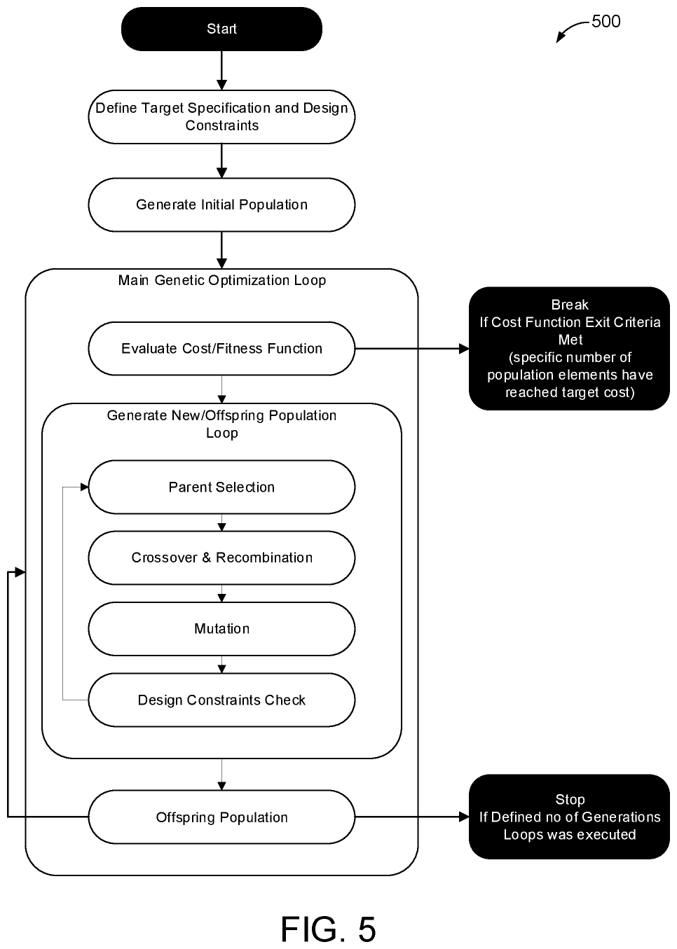

Referring now to FIG. 5, an exemplary block diagram 500 describes a process for generating a set of radar scan configurations. Here, the system begins by generating an initial set of random scan configurations and encodes each random scan configuration into genes to form a population of solutions or scan configurations. Each random scan configuration includes random or pseudo-random values for any number of parameters such as center frequency, wavelength, duty cycle, symbol rate, chirp length, chirp bandwidth, etc.). The population may include any number of random scan configurations (e.g., 10, 100, 1000, etc.). Each population element or solution (i.e., gene or scan configuration) is evaluated against a cost function to assess the quality of the population element or solution.

The cost function is derived from a corresponding system specification or requirements that represent ideal characteristics of a radar scan configuration (e.g., range detection performance over the field of view, cycle time, power requirements, range and velocity resolution, etc.). The cost function determines a difference between the scan configuration and the target or input specification. For example, the larger the difference between the scan configuration and the specification (i.e., the less “ideal” the scan configuration is relative to the specification/requirements), the larger the value the cost function produces (which the system aims to minimize). Conversely, scan configurations that are closer to the specification may produce smaller values. The system determines a cost or “loss” for each random scan configuration. Thus, the cost function determines a quality of the scan configuration relative to the specification. The system may receive the system specification via, for example, selection of parameters by a user interacting with a graphical user interface (GUI) executing on a computing device in communication with the system. The system may receive the system specification via an input test file or other input file that describes or delineates the system specification. Optionally, the system may receive the system specification directly and process/analyze the system specification to derive parameters associated with the specification.

After evaluating the cost (i.e., quality) of each radar scan configuration, the system selects a subset of the population to act as “parents” to a new generation. The selection may be based on the cost values. For example, the system may select 50% (or any other percentage) of the scan configurations with the lowest cost (i.e., the closest to the specification). That is, the system may automatically select a threshold number or amount of the highest quality scan configurations (relative to the input specification). The selection may at least partially be randomized or defined in a probabilistic way. For example, the system may select a portion of the lowest cost scan configurations and then a random sample of the remaining scan configurations (e.g., to add in additional “genetic diversity”). Optionally, the population elements or solutions with the lowest cost have the highest chance of being selected as parents for the next generation.

After selecting the subset of scan configurations (i.e., the parent elements), which may be any amount equal to or less than the original set of scan configurations (e.g., 10%, 50%, 80%, 100%, etc.), the system automatically uses crossover and recombination to “mix” the genes of the selected scan configurations. The system may use any number of configurable variables to perform the crossover and recombination. For example, the system may perform the recombination based on a configurable number of parents for each offspring (e.g., two, three, or more). Each offspring includes a portion of the “genes” (i.e., the radar scan configuration parameters) of each parent. For example, when each offspring has two parents, the offspring may include 50% of the genes from one parent and 50% of the genes from another parent. The gene crossover and recombination may be randomized (e.g., each offspring gets a random selection of genes from each parent). The system may receive the configurable variables via, for example, selection by a user via a GUI executing on a computing device, via a test file or other configuration file, or via analyzing the specification. The crossover and recombination may also be at least partially directed (e.g., based on the cost or loss values or based on other user configurations). Each offspring generated from the subset of scan configurations forms the basis for the next generation of population elements or solutions.

In some examples, the system may mutate one or more genes in one or more offspring. That is, the system may (e.g., randomly) change or adjust one or more genes in one or more offspring such that the adjusted gene is not derived from any parent. Such mutations may help the system “escape” a local minimum or local maximum of the search space. Each gene may have a configurable probability of mutating. For example, each gene may have a 1% or 5% or 10% chance of mutating each generation. The system automatically determines (e.g., using a random number generator or pseudo-random number generator) whether the gene mutates each generation based on the mutation probability for the gene. The mutation may be random (i.e., the system may mutate the gene in a random or pseudo-random manner). For example, the system may randomly select any value for the gene within allowable parameters (i.e., within a minimum and a maximum value for the gene). In other examples, the system randomly selects a value for the gene within a threshold of the current value (e.g., within 10% or within 50% of the current value).

The system, using the new set of offspring, which may or may not include mutations, repeats the process by again evaluating each scan configuration with the cost function. The system may repeat the process for a predetermined number of generations/iterations and/or until one or more scan configurations satisfy a threshold cost value. For example, the system may be configured to generate 10, 100, or 1000 generations and then evaluate the best radar scan configurations (i.e., the radar scan configurations most closely matching the specification). In other examples, the system continues to create new generations or populations until one or more scan configurations satisfy a threshold cost. After completion, the system may report at least a portion (e.g., the top 10, top 100, etc.) of the scan configurations to a user (e.g., the developer or otherwise requestor of the radar scan configurations).

The system may implement additional algorithms (e.g., local searches such as gradient descent, simulated annealing, brute force (i.e., an exhaustive search method where many or all possible combinations are tried), etc.) to further refine the selected scan configurations. In this way, the system may determine an optimal scan configuration for the local minimum or local maximum determined by the global search (e.g., the genetic algorithm). For example, after completing the global search (e.g., after the predetermined number of iterations is reached and/or the threshold cost value is reached), the system may perform a local search using the parameters from the most optimal available scan configurations derived from the global search.

As shown in FIG. 5, the block diagram 500 begins at a start condition and then receives/defines target specification and design constraints. From these constraints, the system generates an initial population. This may include randomly generating an initial set of scan configurations and encoding each into a gene (where the full set of genes together form the population). At this point, the system enters the main genetic optimization loop, which begins with an evaluation of the cost/fitness function. When the cost function exit criteria is met (e.g., a cost threshold is satisfied by one or more of the configurations, a threshold number of iterations is completed, etc.), the loop ends.

For each optimization loop and for each scan configuration (gene) in the population, the system determines the resulting system specification, determines the difference between the result of the current generation and the target system specification, and assigns a cost to each population element accordingly. The optimization goal is to minimize the difference between the scan configuration and the target system specification and therefore achieve the best possible specification. Accordingly, the larger the difference for a given scan configuration the higher cost may be assigned to the scan configuration.

The system uses the evaluated cost assigned to each element of the population to select the best population elements for reproduction (parent genes). The smaller the cost assigned to the specific population element, the higher probability the element has to become a parent and create offspring. The system crosses over and recombines the best candidate genes to generate members of the next population. From the population elements selected for reproduction (i.e., parent genes), the system defines how/what part of their genetic information will be chosen, combined, and propagated into child genes.

For each newly created population element (i.e., offspring gene), the system defines a probability of mutation for individual gene elements (e.g., a gene is a representation of a scan configuration, the mutation has a chance to be triggered and randomly change individual scan configuration parameters). The system then confirms that the newly created child scan configurations based on the recombined genes of the parent scan configurations still fulfill the initial design constraints. If not, the system re-selects the parent scan configurations and creates a new offspring. The system continues to generate offspring scan configurations until the original population size is reached. The system moves the newly generated full offspring population of scan configurations to the next generation and begins a new optimization loop.

Various implementations of the systems and methods described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The system may utilize sensors, such as radar sensors or imaging radar sensors or lidar sensors or the like, to detect presence of and/or range to other vehicles and objects at the intersection. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controlling at least one function or feature of the vehicle (such as to provide autonomous driving control of the vehicle) responsive to processing of the data captured by the radar sensors.

Changes and modifications in the specifically described embodiments can be carried out without departing from the principles of the invention, which is intended to be limited only by the scope of the appended claims, as interpreted according to the principles of patent law including the doctrine of equivalents.

1. A method for generating an optimal scan configuration for a vehicular radar sensing system, the method comprising:
obtaining, from a user device of a designer of the vehicular radar sensing system, a plurality of configurable scan parameters for the vehicular radar sensing system;
receiving a target system specification for the vehicular radar sensing system, wherein the target system specification comprises at least one system specification parameter for the vehicular radar sensing system;
deriving at least one relationship between the plurality of configurable scan parameters and the at least one system specification parameters;
generating, using a genetic algorithm, a population of solutions using the at least one relationship;
determining, from the population of solutions, a potential system specification, wherein the potential system specification defines values for each of the plurality of configurable scan parameters for use by the designer in designing the vehicular radar sensing system;
determining whether the potential system specification satisfies a cost threshold; and
in response to determining that the potential system specification satisfies the cost threshold, providing, to the user device, the potential system specification.

2. The method of claim 1, further comprising, improving, using a local search, the potential system specification.

3. The method of claim 2, wherein the local search comprises one selected from the group consisting of (i) a gradient descent, (ii) a simulated annealing, and (iii) an exhaustive search.

4. The method of claim 1, further comprising defining, for the genetic algorithm, at least one selected from the group consisting of (i) a selection parameter, (ii) a crossover parameter, and (iii) a mutation parameter.

5. The method of claim 1, further comprising, in response to determining that the potential system specification fails to satisfy the cost threshold:
generating a second population of solutions using the population of solutions;
determining, from the second population of solutions, a second potential system specification;
determining whether the second potential system specification satisfies the cost threshold; and
in response to determining that the second potential system specification satisfies the cost threshold, providing the second potential system specification.

6. The method of claim 5, wherein generating the second population of solutions comprises (i) selecting a first portion of the population based on associated cost values and (ii) randomly selecting a second portion of the population.

7. The method of claim 1, wherein the target system specification comprises at least one key performance indicator (KPI).

8. The method of claim 1, further comprising determining, from the population of solutions, a plurality of potential system specifications.

9. The method of claim 8, wherein a quantity of the plurality of potential system specifications is based on a received size parameter.

10. The method of claim 1, wherein the plurality of configurable scan parameters are selected by a user of the user device via interaction with a graphical user interface executing on the user device.

11. A method for generating an optimal scan configuration for a vehicular radar sensing system, the method comprising:
generating a plurality of random radar scan configurations, wherein each radar scan configuration of the plurality of random radar scan configurations comprises a plurality of randomized parameters, and wherein each parameter defines a configurable value for design of the vehicular radar sensing system;
for each respective radar scan configuration of the plurality of random radar scan configurations, determining a cost value using a cost function, wherein the cost function is based on a target system specification comprising at least one system specification parameter;
selecting a subset of radar scan configurations from the plurality of random radar scan configurations based on the cost value of each respective radar scan configuration;
generating, from the subset of radar scan configurations, a second plurality of radar scan configurations;
for each respective radar scan configuration of the second plurality of radar scan configurations, determining the cost value using the cost function; and
providing the subset of the second plurality of radar scan configurations based on the cost values.

12. The method of claim 11, wherein the method further comprises, adjusting at least one radar scan configuration of the subset of the second plurality of radar scan configurations based on a local search algorithm.

13. The method of claim 12, wherein the local search algorithm comprises one selected from the group consisting of (i) a gradient descent algorithm and (ii) a simulated annealing algorithm.

14. The method of claim 11, wherein generating the second plurality of radar scan configurations comprises crossing and recombining randomized parameters from two or more radar scan configurations.

15. The method of claim 11, wherein the method further comprises, for at least one radar scan configuration of the second plurality of radar scan configurations, randomly changing at least one parameter.

16. The method of claim 11, wherein providing the subset of the second plurality of radar scan configurations is in response to determining that at least one radar scan configuration of the second plurality of radar scan configurations satisfies a cost value threshold.

17. The method of claim 11, wherein the cost function evaluates a difference between a respective radar scan configuration and the target system specification.

18. A method for generating an optimal scan configuration for a vehicular radar sensing system, the method comprising:
obtaining, from a user device of a designer of the vehicular radar sensing system, a plurality of configurable scan parameters for the vehicular radar sensing system;
receiving a target system specification for the vehicular radar sensing system, wherein the target system specification comprises at least one system specification parameter for the vehicular radar sensing system;
deriving at least one relationship between the plurality of configurable scan parameters and the at least one system specification parameters;
defining, for a genetic algorithm, at least one selected from the group consisting of (i) a selection parameter, (ii) a crossover parameter, and (iii) a mutation parameter generating, using the genetic algorithm, a population of solutions using the at least one relationship;
determining, from the population of solutions, a potential system specification, wherein the potential system specification defines values for each of the plurality of configurable scan parameters for use by the designer in designing the vehicular radar sensing system;
determining whether the potential system specification satisfies a cost threshold;
in response to determining that the potential system specification satisfies the cost threshold, improving, using a local search, the potential system specification; and
providing, to the user device, the improved potential system specification.

19. The method of claim 18, wherein the local search comprises one selected from the group consisting of (i) a gradient descent, (ii) a simulated annealing, and (iii) an exhaustive search.

20. The method of claim 18, further comprising determining, from the population of solutions, a plurality of potential system specifications.

21. The method of claim 20, wherein a quantity of the plurality of potential system specifications is based on a received size parameter.
